(19) United States
(12) Patent Application Publication
(10) Pub. No.: US 2026/0121875 A1
(43) Pub. Date: Apr. 30, 2026

(54) BLOCKCHAIN ADDRESS AGGREGATION SERVICE

(71) Applicant: Coinbase, Inc., Oakland, CA (US)

(72) Inventors: Jeffrey Daniel Hinojosa, Woodland Hills, CA (US); Jacob Harris Feldman, Loveland, CO (US); Gaurav Gupta, Sunnyvale, CA (US)

(21) Appl. No.: 18/925,818

(22) Filed: Oct. 24, 2024

(51) Int. Cl. H04L 9/00

(52) U.S. Cl. CPC H04L 9/50

(57) ABSTRACT

Methods, systems, and devices for data management are described. A client application may receive a first user input to connect the client application to a blockchain address application that is associated with multiple blockchain addresses, where blockchain addresses of the multiple blockchain addresses are associated with at least two different transaction handling models of different blockchain networks. The client application may display information associated with the multiple blockchain addresses, where the information includes a first amount of a first crypto token associated with a first blockchain address and a second amount of a second crypto token associated with a second blockchain address. The client application may receive second user inputs to perform an operation on a blockchain network using a blockchain address of the multiple blockchain addresses. The client application may initiate the operation on the blockchain network after receiving the second user inputs.

### FIELD OF TECHNOLOGY

The present disclosure relates generally to data management, including techniques for a blockchain address aggregation service.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support a blockchain address aggregation service in accordance with aspects of the present disclosure.

FIGS. 3 and 4 show examples of user interface flows that support a blockchain address aggregation service in accordance with aspects of the present disclosure.

FIG. 5 shows an example of a process flow that supports a blockchain address aggregation service in accordance with aspects of the present disclosure.

FIG. 6 shows a block diagram of an apparatus that supports a blockchain address aggregation service in accordance with aspects of the present disclosure.

FIG. 7 shows a block diagram of a blockchain address aggregation manager that supports a blockchain address aggregation service in accordance with aspects of the present disclosure.

FIG. 8 shows a diagram of a system including a device that supports a blockchain address aggregation service in accordance with aspects of the present disclosure.

FIGS. 9 and 10 show flowcharts illustrating methods that support a blockchain address aggregation service in accordance with aspects of the present disclosure.

### DETAILED DESCRIPTION

Some applications, such as blockchain address applications or decentralized applications (Dapps), may support aggregated display of information associated with multiple blockchain addresses. For example, a user may connect blockchain addresses individually to an application, and the application may display information of each individually connected blockchain address. That is, a user interface flow to connect a blockchain address to the application may support connection of only one blockchain address at a time. Additionally, applications may support use of a designated or active blockchain address. For example, the application may establish a single connection with a single blockchain address application provider at a time, where the user may perform operations using blockchain addresses of the connected blockchain address application provider. To use a blockchain address of a different blockchain address application provider, the user may select or designate a different blockchain address, and the application may terminate a connection with the blockchain address application provider and establish a connection with a different blockchain address application provider. The individual connection of blockchain addresses and availability of only one blockchain address application for operation on a blockchain network at a time may be associated with poor user experience, increased resource overhead, and reduced capabilities for operating on blockchain networks compared to techniques described herein.

As described herein, a client application may support connection of multiple blockchain addresses across different blockchain applications, different blockchain networks, and/or different blockchains on a same blockchain network at a same time. For example, the client application may receive user inputs to connect the client application to a blockchain address application associated with multiple blockchain addresses, where the multiple blockchain addresses are associated with multiple different transaction handling models, blockchain networks, or both. That is, rather than connecting blockchain addresses to an application individually or on a per-blockchain network or transaction handling model basis, techniques described herein support connection of a blockchain address application associated with blockchain addresses that are associated with different transaction handling models and/or blockchain networks through a single user input or input flow. Additionally, the client application may support performance of operations on a blockchain network using any of the multiple connected blockchain addresses. That is, the client application may support multiple “active” or available blockchain addresses by maintaining concurrent connections with multiple blockchain address applications. Techniques described herein may support enhanced user functionality related to viewing information associated with and performing operations using multiple blockchain addresses across different transaction handling models, blockchain address applications, blockchain networks, or the like.

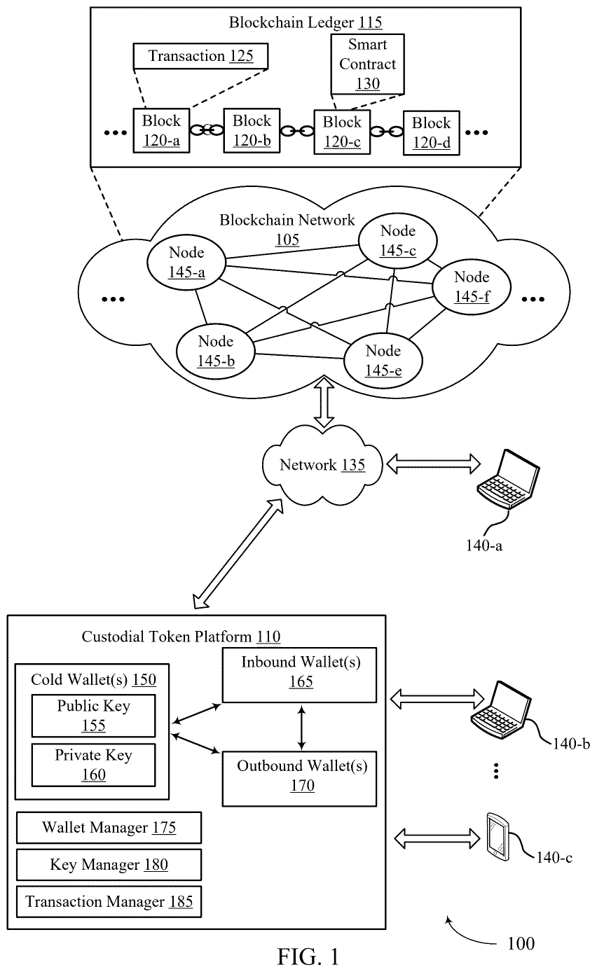

FIG. 1 illustrates an example of a computing environment 100 that supports a blockchain address aggregation service in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the mart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, an application may support connection of multiple blockchain addresses across different blockchain applications and/or different blockchain networks at a same time. For example, a client application, such as a client application associated with the custodial token platform 110, may receive a first user input to connect the client application to a blockchain address application that is associated with multiple blockchain addresses, where blockchain addresses of the multiple blockchain addresses are associated with at least two different transaction handling models of different blockchain networks (e.g., including the blockchain network 105). The client application may display information associated with the multiple blockchain addresses, where the information includes a first amount of a first crypto token associated with a first blockchain address and a second amount of a second crypto token associated with a second blockchain address. The client application may receive second user inputs to perform an operation on a blockchain network using a blockchain address of the multiple blockchain addresses. The client application may initiate the operation on the blockchain network after receiving the second user inputs.

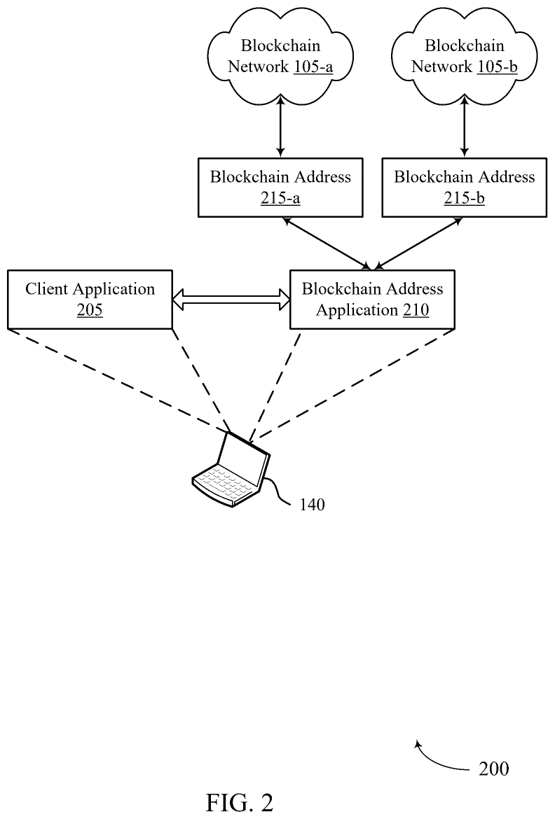

FIG. 2 shows an example of a computing environment 200 that supports a blockchain address aggregation service in accordance with aspects of the present disclosure. The computing environment 200 may include a blockchain network 105-a, a blockchain network 105-b, and a computing device 140 (e.g., a user device), which may be examples of corresponding devices or systems as described with reference to FIG. 1. Additionally, the computing environment 200 may include a client application 205 and a blockchain address application 210, which may be examples of applications associated with or otherwise supported by the custodial token platform 110.

A user may connect multiple blockchain addresses for aggregated display at the client application 205. For example, the user may select multiple addresses from the client application 205 (e.g., or an extension thereof, such as a browser extension). The client application 205 may display a list of blockchain addresses having a capability to connect for aggregated display at the client application 205. In some examples, the client application 205 may, by default, select or display, for connection, blockchain addresses having a positive, non-zero amount of crypto token. In the example of FIG. 2, the client application 205 may display at least an option to connect a blockchain address 215-a and a blockchain address 215-b of a blockchain address application 210.

The blockchain address 215-a and the blockchain address 215-b may be associated with different blockchain networks. For example, the blockchain address 215-a may be of a blockchain network 105-a while the blockchain address 215-b may be of a blockchain network 105-b. The blockchain network 105-a and the blockchain network 105-b may use different transaction handling models. That is, the blockchain network 105-a and the blockchain network 105-b may handle transactions in different manners, including according to different rules. In some examples, transaction handling models are associated with one or more different consensus mechanisms (e.g., proof of work, proof of stake). An example of a transaction handling model may be an unspent transaction output (UTXO) model in which each transaction includes inputs and outputs or an account/balance model that tracks a balance of each account as a global state. The bitcoin blockchain network may be an example of a UTXO model, and the Ethereum blockchain network may be an example an account/balance model.

The client application 205 may be an example of a website, webservice, standalone application, mobile application, or the like, and may be supported by one or more servers, such as a server associated with or supporting the custodial token platform 110 of FIG. 1, and the one or more servers may facilitate blockchain wallet application connections as described herein. The client application 205 may connect or link multiple blockchain address providers at the same time. For example, based on receiving user inputs to connect multiple blockchain addresses associated with different blockchain address providers, the client application 205 may establish connections with each of the different blockchain address providers. That is, after receiving user inputs to connect the blockchain address 215-a and the blockchain address 215-b of the blockchain address application 210, the client application 205 may receive additional user inputs to connect blockchain addresses of a different blockchain address application (e.g., a different blockchain address provider). The client application 205 may establish a single connection for the different blockchain address providers or multiple, separate, concurrently maintained connections to the different blockchain address providers.

As used herein, connections between the client application 205 and the blockchain address providers may be maintained via connectors. The client application 205 may include a connector manager. For example, the connector manager may have an instance to a connector of each blockchain and map requests to a node of the respective blockchain. That is, the connector manager may receive or intercept requests to interact with a blockchain network, the connector manager may route the requests to the correct node to handle the request.

A user may perform one or more cryptographic operations via the client application 205. For example, the client application 205 may display one or more options to perform cryptographic operations (e.g., buy, swap, send, receive, stake, add/remove liquidity) using any of the connected blockchain addresses. In some examples, the user may perform multiple cryptographic operations (e.g., read or write operations) on multiple blockchains, blockchain addresses, or blockchain networks concurrently. For example, the user may view balances, transactions, or both associated with the multiple blockchains, blockchain addresses, or blockchain networks. Additionally, or alternatively, the user may mutate a state of different blockchains, blockchain addresses, or blockchain networks at a same time using the techniques described herein. For example, to mutate the state of the blockchain the user may perform one or more operations that causes one or more transactions or messages to be sent via the blockchain network such as to update the state of the corresponding blockchain ledger. That is, the state of the blockchain may be updated based on various actions such as transacting, sending, receiving, swapping, bridging, etc. The client application 205 may receive one or more inputs to perform a cryptographic operation via a user interface that displays information associated with the multiple connected blockchain addresses.

By maintaining concurrent connections with the multiple blockchain address providers, the client application 205 may enable the user to perform cryptographic operations using any connected blockchain address at any time. For example, the multiple connected blockchain addresses may be designated as “active” or otherwise available to perform cryptographic operations based on the client application 205 having connections with each blockchain address provider at a same time.

A user may disconnect one or more blockchain addresses for aggregated display at the client application 205. For example, the client application 205 may display an option to disconnect blockchain addresses. The client application 205 may receive one or more user inputs indicating a selection of one or more blockchain addresses to be disconnected. The client application 205 may terminate a connection to one or more blockchain address providers associated with the one or more blockchain addresses selected to be disconnected. For example, if a user selects blockchain addresses of the blockchain address application 210 to be disconnected, the client application 205 may terminate a connection with the blockchain address application 210. Additionally, or alternatively, the client application 205 may update a display of a user interface such that the information displayed is absent information associated with the one or more blockchain addresses that are disconnected. In some examples, the user may disconnect all connected addresses at the same time. In such examples, the client application 205 may update the display such that the user is logged out of the client application 205.

In some examples, a user may view and revoke token allowances via the client application 205. For example, the client application may include one or more options to add, change, or remove permissions that allow Dapps or smart contracts to interact with tokens of a blockchain address of the user and complete transactions.

The client application 205 may synchronize (e.g., update) the aggregated display. For example, the client application 205 may synchronize the display of information associated with the multiple blockchain addresses periodically, based on a user input, or both. In some examples, the client application 205 may display, as a default, an option to synchronize all blockchain addresses.

In some examples, the blockchain address 215-a, the blockchain address 215-b, or both may be examples of smart wallets. Smart wallets, as described herein, may be passkey-based wallets. A passkey may be an example of a digital credential bound to a user account, such as an email account, or a hardware device and a website or application, such as the client application 205 or a blockchain address application 210. In other words, passkeys may be associated with user accounts or hardware devices and may be uniquely bound to a domain. For example, passkeys may be stored at a location that is associated with the user account or hardware device (e.g., in a secure enclave, a cloud, on the hardware device, etc.). Additionally, passkeys may be usable on the domain that they are bound to (e.g., and not on other domains). Creating a smart wallet may involve creating a passkey. For example, a user may create a passkey bound to a user account (e.g., of the client application, or a different account) and bound to a domain of the client application 205. The passkey may be used to encrypt a private key. Additionally, smart wallets may not involve recovery phrases (e.g., recovery phrases for externally owned account (EOA) wallets).

To obtain information associated with the connected blockchain addresses, the client application 205 may request the information from the blockchain addresses. For example, the client application 205 may ping the blockchain networks, blockchain data providers, or both for information associated with blockchain address 215-a and the blockchain address 215-b to obtain information associated with the respective blockchain addresses.

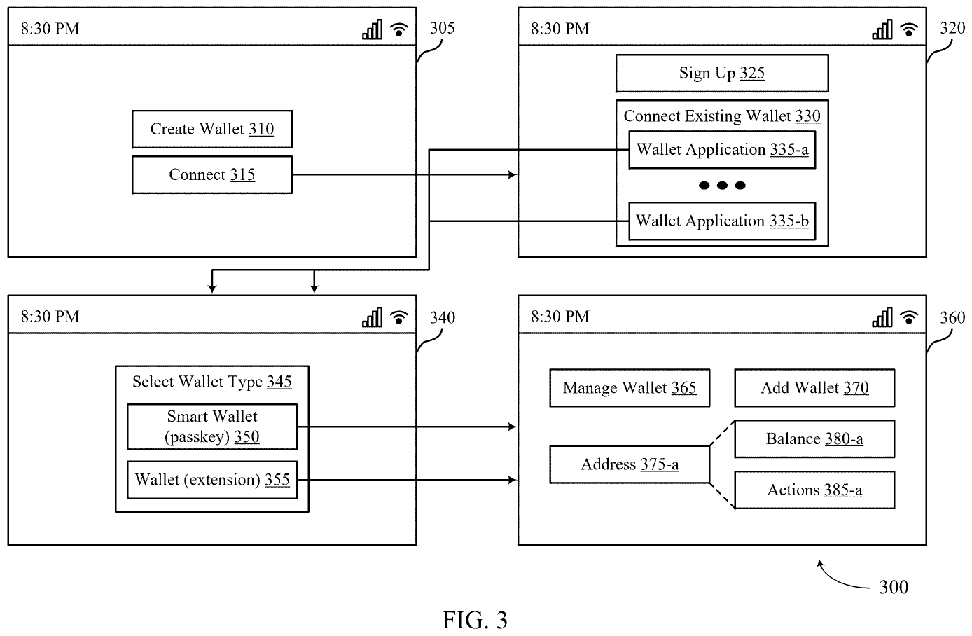

FIG. 3 shows an example of a user interface flow 300 that supports a blockchain address aggregation service in accordance with aspects of the present disclosure. In some examples, the user interface flow 300 may implement or be implemented by aspects of the computing environment 100, the computing environment 200, or both. For example, the user interface flow 300 may illustrate a display of one or more indications at a client application on a computing device, such as the client application 205 on the computing device 140 as described with reference to FIG. 2. Alternative examples of the following user interface flow may be implemented, where display of some indications may be in a different order than described or are not displayed at all. The user interface flow 300 may include additional indications not mentioned below, or further indications may be added.

A user interface 305 may include an option to create a wallet 310 or connect 315. The option to create a wallet 310 may refer to an option to create a smart wallet. For example, a user may provide an input, via the user interface 305, to create a wallet 310 (e.g., a smart wallet). Alternatively, the user may provide an input, via the user interface 305, to connect 315 a wallet, including a newly created wallet or an existing wallet. In the example of FIG. 3, the user may select the option to connect 315 the wallet.

A user interface 320 may include an option to sign up 325, connect an existing wallet 330, and a list of wallet applications, including a wallet application 335-a and a wallet application 335-b. The user may select the option to sign up 325 to create a wallet at the client application. Alternatively, the user may select a wallet application of the list of wallet applications to connect an existing wallet 330. In the example of FIG. 3, the user may select the option to connect an existing wallet 330, such as select one of the wallet application 335-a or the wallet application 335-b.

A user interface 340 may include an option to select a wallet type 345 from a smart wallet (passkey) 350 or a wallet (extension) 355. For example, the wallet application 335-a or the wallet application 335-b may support multiple wallet types, including smart wallets or EOA wallets. The user may select either of the wallet types to connect. That is, in the example of FIG. 3, the user may select the smart wallet (passkey) 350 or the wallet (extension) 355.

A user interface 360 may include an option to manage a wallet 365, an option to add a wallet 370, and information associated with the connected wallet, including an address 375-a, a balance 380-a, and actions 385-a. For example, a user may manage a connected wallet by selecting the option to manage a wallet 365 or add another wallet by selecting the option to add a wallet 370. The balance 380-a may refer to an amount of a crypto token associated with the address 375-a, which may be an example of a blockchain address of the connected wallet (e.g., the wallet selected at the user interface 340). The actions 385-a may refer to transactions or history associated with the address 375-a.

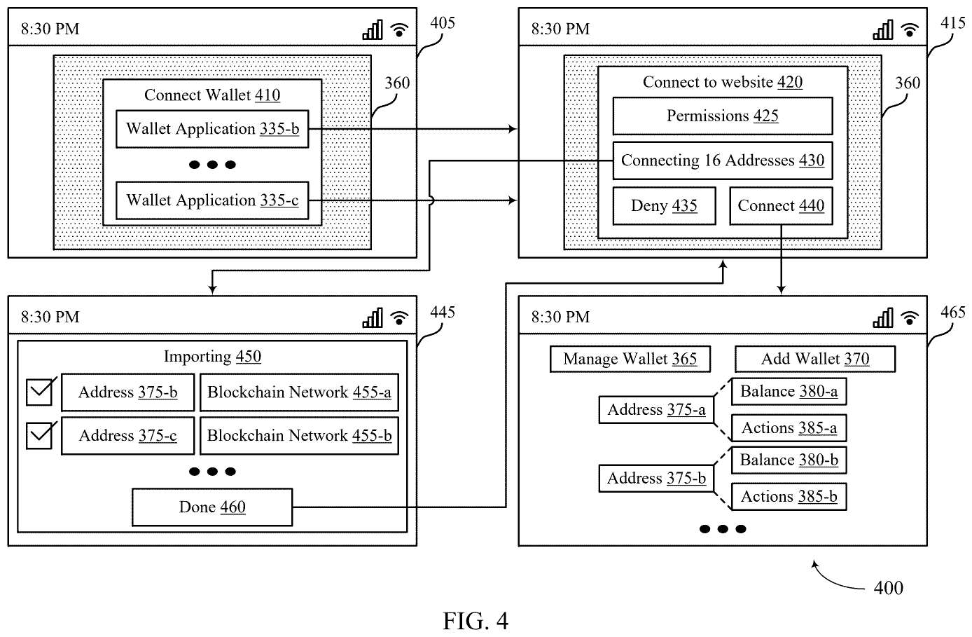

FIG. 4 shows an example of a user interface flow 400 that supports a blockchain address aggregation service in accordance with aspects of the present disclosure. In some examples, the user interface flow 400 may implement or be implemented by aspects of the computing environment 100, the computing environment 200, or both. For example, the user interface flow 400 may illustrate a display of one or more indications at a client application on a computing device, such as the client application 205 on the computing device 140 as described with reference to FIG. 2. Alternative examples of the following user interface flow may be implemented, where display of some indications may be in a different order than described or are not displayed at all. The user interface flow 400 may include additional indications not mentioned below, or further indications may be added.

The user interface flow 400 may occur after the user interface flow 300. For example, a user interface 405 may be displayed after selection of the option to add a wallet 370 as described with reference to FIG. 3. In such examples, one or more of the user interfaces of the user interface flow 400 may be examples of pop-ups that are superimposed on or otherwise in front of the user interface 360. Particularly, a user interface 405 and a user interface 415 may include a pop-up element that is in front of elements of the user interface 360. Alternatively, the user interface flow 400 may occur without prior connection of a wallet.

The user interface 405 may include an option to connect a wallet 410 from a list of wallet applications, including a wallet application 335-b and a wallet application 335-c. After selection of one of the wallet application 335-b or the wallet application 335-c, a user interface 415 may include an option to connect to a website 420 (e.g., a website of the selected wallet application), an indication of permissions 425, an indication of selected addresses to connect (e.g., connecting 16 addresses 430), an option to deny 435, and an option to connect 440. The indication of the selected addresses to connect may include an indication of a quantity of addresses of the wallet application that are to be connected. Selection of the indication of the selected addresses may enable the user to modify the selected addresses.

For example, the user interface 445 may display an indication of importing 450 for multiple addresses, including an address 375-b of a blockchain network 455-a, an address 375-c of a blockchain network 455-b, and so on. A user may modify selection of the addresses at the user interface 445. For example, a user may provide one or more inputs to select or de-select addresses to import. The user may select done 460 to return to the user interface 415 and complete the connection by selecting the option to connect 440.

A user interface 465 may display an option to manage a wallet 365, an option to add a wallet 370, and a list of blockchain addresses and associated information. For example, the user interface 465 may display the address 375-a, a balance 380-a and actions 385-a associated with the address 375-a, the address 375-b, and a balance 380-b and actions 385-b associated with the address 375-b. While two blockchain addresses and associated information are shown in the example of FIG. 4, it may be understood that the user interface 465 may display information associated with more than two blockchain addresses.

A user may provide one or more inputs to filter the information associated with the connected blockchain addresses. For example, the client application may receive one or more inputs to display information associated with one or more blockchain networks (e.g., filter by a type of crypto token), one or more blockchain addresses, or both. As an example, the client application may display information associated with blockchain addresses of a set of blockchain networks (e.g., multiple blockchain networks), and the client application may receive an input to and subsequently display information associated with blockchain addresses of a subset of the set of blockchain networks (e.g., a subset including fewer blockchain networks than the set of blockchain networks). Similarly, the client application may display information associated with a set of blockchain addresses (e.g., multiple blockchain addresses), and the client application may receive an input to and subsequently display information associated with a subset of the set of blockchain addresses (e.g., a subset including fewer blockchain addresses than the set of blockchain addresses). In some examples, deselecting a blockchain network or a blockchain address when the blockchain network or the blockchain addresses was singularly displayed may cause the client application to, by default, display information associated with the set of blockchain networks or the set of blockchain addresses (e.g., all blockchain networks or addresses).

The information may include a crypto token type (e.g., a name of a crypto token, such as Bitcoin, Eth, etc.), a balance, a portfolio percentage (e.g., a percentage of an overall portfolio asset value that the balance makes up across all displayed blockchain addresses), a blockchain address (e.g., or an indication thereof, such as an icon or avatar), a price, or any combination thereof. The client application may receive one or more inputs to sort the information, such as according to an alphabetical order (e.g., for the crypto token type, blockchain address, etc.), ascending or descending value (e.g., for the balance portfolio percentage, price, etc.), or the like.

In some examples, the information may include NFTs, collections, decentralized finance (DeFi) positions, and the like. For example, in addition to or alternatively from displaying information associated with crypto tokens of the connected blockchain addresses, the client application may display information associated with other asset types, including NFTs (e.g., in a grid or list view, according to a collection, etc.) and DeFi positions.

The information may include transactions of the connected blockchain addresses. For example, the client application may display transaction information associated with each of the connected blockchain addresses, including one or more crypto token types, one or more crypto token amounts, a transaction type (e.g., buy, swap, send, receive, stake, etc.), a status of the transaction, or the like. In the example of a swap, the client application may display an exchange of a first amount of a first crypto token associated with a first blockchain address for a second amount of a second crypto token associated with a second blockchain address. In some examples, the client application may update the user interface after initiating the swap via the blockchain network, such as in an example where the swap is initiated via the client application (e.g., rather than a blockchain address application associated with either of the first blockchain address or the second blockchain address).

In some examples, the information may include one or more positions or balances that are available for staking. For example, the client application may indicate which of the multiple displayed blockchain addresses are associated with balances or positions that the user may opt to stake. Additionally, or alternatively, the client application may display information associated with staked tokens. For example, the information may include estimated returns, actual returns, or both associated with staked tokens.

A user may designate a fiat for display of the information of the multiple blockchain addresses. For example, the client application may receive one or more inputs indicating a fiat currency, where the information is displayed in accordance with the fiat currency. As an example, the client application may display one or more parameters, including a summary of crypto tokens associated with the connected blockchain addresses, in terms of the fiat currency.

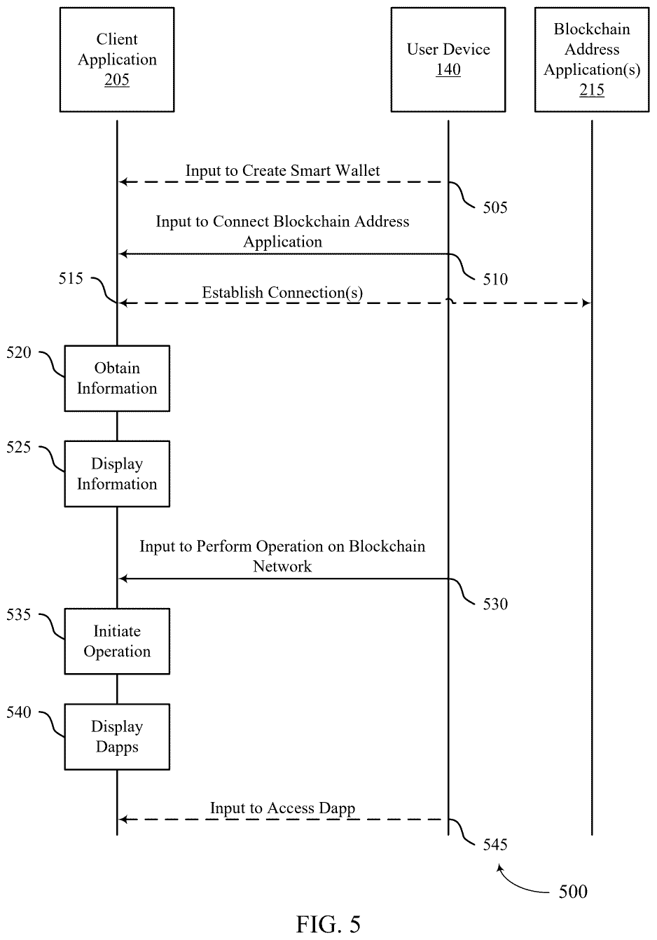

FIG. 5 shows an example of a process flow 500 that supports a blockchain address aggregation service in accordance with aspects of the present disclosure. In some examples, the process flow 500 may implement or be implemented by the computing environment 100, the computing environment 200, the user interface flow 300, the user interface flow 400, or any combination thereof. For example, the process flow 500 may include a client application 205, a computing device 140, and blockchain address application(s) 215, which may be examples of the corresponding devices or systems as described with reference to FIGS. 1 and 2.

Alternative examples of the following may be implemented, where some operations are performed in a different order than described or are not performed at all. In some cases, operations may include additional features not mentioned below, or further operations may be added. Although the client application 205, the computing device 140, and the blockchain address application(s) 215 are shown performing the operations of the process flow 500, some aspects of some operations may also be performed by one or more other components.

At 505, the client application 205 may receive, via a user interface of the client application 205 at the computing device 140, an input to create a smart wallet. For example, the client application 205 may receive, via the user interface and prior to the user input at 510, one or more user inputs to create a smart wallet. In other words, a user may create the smart wallet via the client application 205 prior to connecting the smart wallet.

At 510, the client application 205 may receive, via a user interface of the client application 205 at the computing device 140, an input to connect a blockchain address application. For example, the client application 205 may receive, via a user interface, a user input to connect the client application to a blockchain address application that is associated with multiple blockchain addresses. A first blockchain address of the multiple blockchain addresses may be associated with a first transaction handling model of a first blockchain network and a second blockchain address of the multiple blockchain addresses may be associated with a second transaction handling model of a second blockchain network.

In some examples, the first blockchain address may be a smart wallet that performs cryptographic operations using a passkey including a string of characters stored on a computing device 140. The smart wallet may be an example of a smart wallet described in greater detail elsewhere herein, including with reference to FIG. 2. The client application 205 may connect the smart wallet based on receiving the inputs to create the smart wallet at 505 or based on the smart wallet having been created at another application prior to the user inputs at 510.

At 515, the client application 205 may establish connection(s) with the blockchain address application(s) 215. For example, the client application 205 may establish, in response to the user input at 510, a first connection to a blockchain address application. The client application 205 may receive additional user inputs to connect the client application 205 to a second blockchain address application associated with at least one third blockchain address. In such examples, the client application 205 may establish, in response to the additional user inputs, a second connection to the second blockchain address application. The client application 205 may maintain the first connection and the second connection concurrently, where the multiple blockchain addresses associated with the blockchain address application(s) 215 are available for operation on the blockchain network via the first connection or the second connection.

At 520, the client application 205 may obtain information. For example, the client application 205 may obtain the information by requesting information from respective blockchain addresses of the multiple blockchain addresses (e.g., via respective blockchain networks, blockchain data providers). That is, the client application 205 may transmit a first request for information associated with the first blockchain address to a first blockchain network or data provider associated with the first blockchain address. The client application 205 may receive, in response to the first request, a first response including the information associated with the first blockchain address, the information including a first amount of a first crypto token associated with the first blockchain address. Additionally, the client application 205 may transmit a second request for information associated with the second blockchain address to a second blockchain network or data provider. The client application 205 may receive, in response to the second request, a second response including the information associated with the second blockchain address, the information including a second amount of a second crypto token associated with the second blockchain address.

At 525, the client application 205 may display information. For example, the client application 205 may display, via the user interface and after receiving the user input at 510, information associated with the multiple blockchain addresses. The information may include a first amount of a first crypto token associated with the first blockchain address and a second amount of a second crypto token associated with the second blockchain address. That is, the client application 205 may display information of multiple blockchain addresses of different transaction handling models, different blockchain networks, or both. In some examples, the client application 205 may display one or more Ethereum Name Services (ENSs) of the user. For example, for each connected blockchain address, the client application 205 may display the address, a blockchain, a balance, and an ENS (e.g., an ENS resolution, such as via identity resolution). Additionally, or alternatively, the information may include one or more DeFi positions of respective blockchain addresses of the multiple blockchain addresses. The client application 205 may display the information at 525 based on obtaining the information at 520. That is, the client application 205 may display the information based on the first response and the second response.

The client application 205 may display a summation of fiat amounts corresponding to amounts of crypto tokens associated with the multiple blockchain addresses. For example, the client application 205 may display a summation of a first fiat amount and a second fiat amount, where the first fiat amount corresponds to the first amount of the first crypto token according to a first exchange rate between a fiat and the first crypto token, and the second fiat amount corresponds to the second amount of the second crypto token according to a second exchange rate between the fiat and the second crypto token.

The client application 205 may display filtered information. For example, the client application 205 may receive, via the user interface, one or more user inputs to display information associated with the first crypto token. In other words, the client application 205 may receive one or more user inputs indicating to filter the display of information to show information associated with the first crypto token. The client application 205 may display, via the user interface and in response to the one or more user inputs, the information associated with the first crypto token, the information including the first amount of the first crypto token associated with the first blockchain address.

At 530, client application 205 may receive, via a user interface of the client application 205 at the computing device 140, an input to perform an operation on a blockchain network. For example, the client application 205 may receive, via the user interface, one or more user inputs to perform an operation on a blockchain network using a blockchain address of the multiple blockchain addresses That is, the client application may enable initiation of operations by multiple blockchain addresses of different transaction handling models, different blockchain networks, or both.

The client application 205 may display one or more visual representations of the multiple blockchain addresses for selection for performance of the operation on the blockchain network. That is, the multiple blockchain addresses may be “active” or otherwise available to perform operations on the blockchain network via the client application 205. The client application 205 may receive the input to perform the operation based on displaying the one or more visual representations.

At 535, the client application 205 may initiate the operation. For example, the client application 205 may initiate the operation on the blockchain network after receiving the one or more user inputs at 530. In some examples, the operation may include a swap involving blockchain addresses associated with different blockchain address applications. For example, the operation may include an exchange of a third amount of a third crypto token associated with the blockchain address for a fourth amount of a fourth crypto token associated with a different blockchain address of the multiple blockchain addresses, where the blockchain address is associated with the blockchain address application and the different blockchain address is associated with the second blockchain address application. To initiate the operation, the client application 205 may communicate transaction information to the respective blockchain address application, a backend supporting the blockchain address application, broadcast one or more messages (e.g., transactions) via the corresponding blockchain network, or any combination thereof.

The client application 205 may update a user interface based on the operation being executed on the blockchain network. For example, the client application 205 may update, after initiating the operation on the blockchain network at 535, the user interface of the client application 205 to display updated information. The updated information may include the third amount of the third crypto token associated with the different blockchain address and the fourth amount of the fourth crypto token associated with the blockchain address.

At 540, the client application 205 may display Dapps. For example, the client application 205 may display, via the user interface, one or more third-party Dapps accessible via the client application 205. At 545, the client application 205 may receive, via a user interface of the client application 205 at the computing device 140, an input to access a Dapp. For example, the client application 205 may receive, via the user interface, one or more user inputs to access a third-party Dapp of the one or more third-party Dapps using the blockchain address of the multiple blockchain addresses.

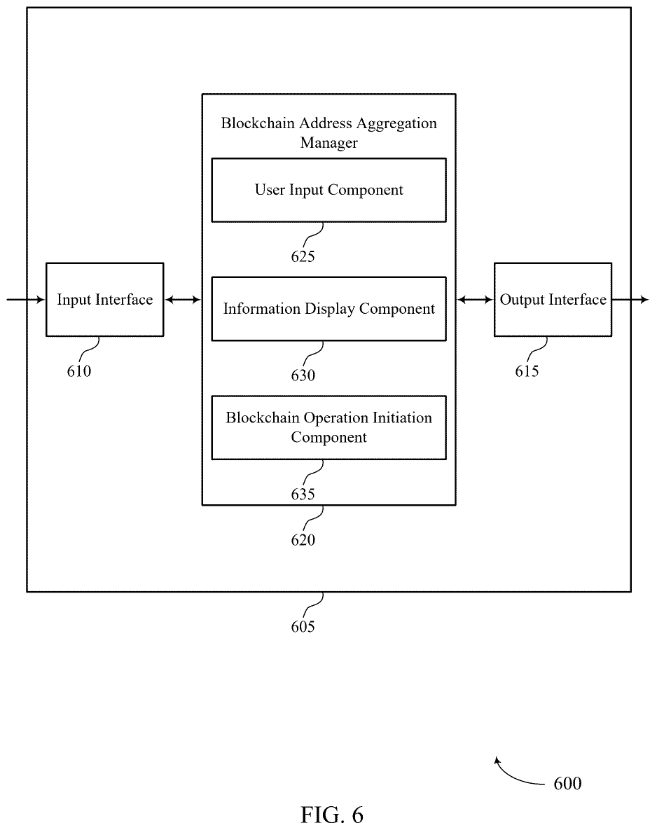

FIG. 6 shows a block diagram 600 of a system 605 that supports a blockchain address aggregation service in accordance with aspects of the present disclosure. The system 605 may include an input interface 610, an output interface 615, and a blockchain address aggregation manager 620. The system 605, or one or more components of the system 605 (e.g., the input interface 610, the output interface 615, the blockchain address aggregation manager 620), may include at least one processor, which may be coupled with at least one memory, to support the described techniques. Each of these components may communicate, directly or indirectly, with one another (e.g., via one or more buses, communications links, communications interfaces, or any combination thereof).

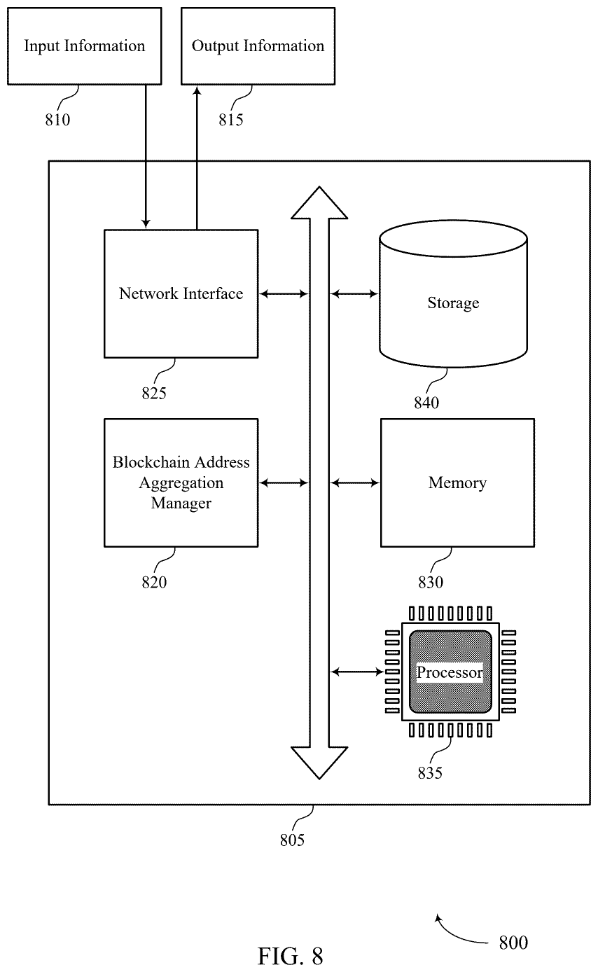

The input interface 610 may manage input signaling for the system 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the blockchain address aggregation manager 620 to support a blockchain address aggregation service. In some cases, the input interface 610 may be a component of a network interface 825 as described with reference to FIG. 8.

The output interface 615 may manage output signaling for the system 605. For example, the output interface 615 may receive signaling from other components of the system 605, such as the blockchain address aggregation manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the blockchain address aggregation manager 620 may include a user input component 625, an information display component 630, a blockchain operation initiation component 635, or any combination thereof. In some examples, the blockchain address aggregation manager 620, or various components thereof, may be configured to perform various operations (e.g., receiving, monitoring, transmitting) using or otherwise in cooperation with the input interface 610, the output interface 615, or both. For example, the blockchain address aggregation manager 620 may receive information from the input interface 610, send information to the output interface 615, or be integrated in combination with the input interface 610, the output interface 615, or both to receive information, transmit information, or perform various other operations as described herein.

The user input component 625 may be configured as or otherwise support a means for receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network. The information display component 630 may be configured as or otherwise support a means for displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address. The user input component 625 may be configured as or otherwise support a means for receiving, via the user interface of the client application, one or more second user inputs to perform an operation on a blockchain network using a blockchain address of the plurality of blockchain addresses. The blockchain operation initiation component 635 may be configured as or otherwise support a means for initiating, via the client application, the operation on the blockchain network after receiving the one or more second user inputs.

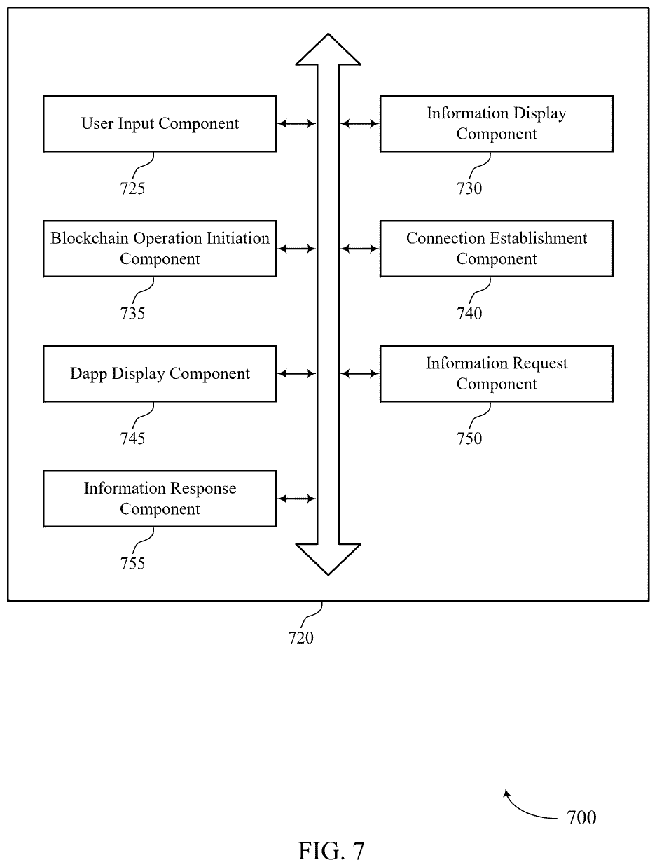

FIG. 7 shows a block diagram 700 of a blockchain address aggregation manager 720 that supports a blockchain address aggregation service in accordance with aspects of the present disclosure. The blockchain address aggregation manager 720 may be an example of aspects of a blockchain address aggregation manager or a blockchain address aggregation manager 620, or both, as described herein. The blockchain address aggregation manager 720, or various components thereof, may be an example of means for performing various aspects of a blockchain address aggregation service as described herein. For example, the blockchain address aggregation manager 720 may include a user input component 725, an information display component 730, a blockchain operation initiation component 735, a connection establishment component 740, a Dapp display component 745, an information request component 750, an information response component 755, or any combination thereof. Each of these components may communicate, directly or indirectly, with one another (e.g., via one or more buses, communications links, communications interfaces, or any combination thereof).

The user input component 725 may be configured as or otherwise support a means for receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network. The information display component 730 may be configured as or otherwise support a means for displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address. In some examples, the user input component 725 may be configured as or otherwise support a means for receiving, via the user interface of the client application, one or more second user inputs to perform an operation on a blockchain network using a blockchain address of the plurality of blockchain addresses. The blockchain operation initiation component 735 may be configured as or otherwise support a means for initiating, via the client application, the operation on the blockchain network after receiving the one or more second user inputs.

In some examples, the connection establishment component 740 may be configured as or otherwise support a means for establishing, in response to the first user input, a first connection to the blockchain address application. In some examples, the user input component 725 may be configured as or otherwise support a means for receiving one or more third user inputs to connect the client application to a second blockchain address application associated with at least one third blockchain address. In some examples, the connection establishment component 740 may be configured as or otherwise support a means for establishing, in response to the one or more third user inputs, a second connection to the second blockchain address application, wherein the first connection and the second connection are maintained by the client application concurrently, wherein the plurality of blockchain addresses and the at least one third blockchain address are available for the operation on the blockchain network via the first connection or the second connection.

In some examples, the operation on the blockchain network comprises an exchange of a third amount of a third crypto token associated with the blockchain address for a fourth amount of a fourth crypto token associated with a different blockchain address of the plurality of blockchain addresses. In some examples, the blockchain address is associated with the blockchain address application and the different blockchain address is associated with the second blockchain address application.

In some examples, the first blockchain address comprises a smart wallet that performs cryptographic operations using a passkey comprising a string of characters stored on a user device.

In some examples, the user input component 725 may be configured as or otherwise support a means for receiving, via the user interface of the client application and prior to the first user input, one or more third user inputs to create the smart wallet.

In some examples, the Dapp display component 745 may be configured as or otherwise support a means for displaying, via the user interface of the client application, one or more third-party Dapps accessible via the client application. In some examples, the user input component 725 may be configured as or otherwise support a means for receiving, via the user interface of the client application, one or more third user inputs to access a third-party Dapp of the one or more third-party Dapps using the blockchain address of the plurality of blockchain addresses.

In some examples, the information associated with the plurality of blockchain addresses further comprises one or more DeFi positions of respective blockchain addresses of the plurality of blockchain addresses.

In some examples, the information request component 750 may be configured as or otherwise support a means for transmitting a first request for the information associated with the first blockchain address to the first blockchain address. In some examples, the information response component 755 may be configured as or otherwise support a means for receiving, in response to the first request, a first response comprising the information associated with the first blockchain address, the information comprising the first amount of the first crypto token associated with the first blockchain address. In some examples, the information request component 750 may be configured as or otherwise support a means for transmitting a second request for information associated with the second blockchain address to the second blockchain address. In some examples, the information response component 755 may be configured as or otherwise support a means for receiving, in response to the second request, a second response comprising the information associated with the second blockchain address, the information comprising the second amount of the second crypto token associated with the second blockchain address, wherein displaying the information is based at least in part on the first response and the second response.

In some examples, to support displaying the information, the information display component 730 may be configured as or otherwise support a means for displaying a summation of a first fiat amount and a second fiat amount, wherein: the first fiat amount corresponds to the first amount of the first crypto token according to a first exchange rate between a fiat and the first crypto token, and the second fiat amount corresponds to the second amount of the second crypto token according to a second exchange rate between the fiat and the second crypto token.

In some examples, the user input component 725 may be configured as or otherwise support a means for receiving, via the user interface of the client application, one or more third user inputs to display information associated with the first crypto token. In some examples, the information display component 730 may be configured as or otherwise support a means for displaying, via the user interface of the client application and in response to the one or more third user inputs, the information associated with the first crypto token, the information comprising the first amount of the first crypto token associated with the first blockchain address.

In some examples, one or more visual representations of the plurality of blockchain addresses are displayed for selection for performance of the operation on the blockchain network.

In some examples, the operation on the blockchain network comprises an exchange of a third amount of a third crypto token associated with the blockchain address for a fourth amount of a fourth crypto token associated with a different blockchain address of the plurality of blockchain addresses, and the information display component 730 may be configured as or otherwise support a means for updating, after initiating the operation on the blockchain network, the user interface of the client application to display updated information, the updated information comprising the third amount of the third crypto token associated with the different blockchain address and the fourth amount of the fourth crypto token associated with the blockchain address.

In some examples, the connection establishment component 740 may be configured as or otherwise support a means for establishing, in response to the first user input, a connection to a blockchain address application associated with the plurality of blockchain addresses, wherein the plurality of blockchain addresses are available for the operation on the blockchain network via the connection.

FIG. 8 shows a diagram of a system 800 including a system 805 that supports a blockchain address aggregation service in accordance with aspects of the present disclosure. The system 805 may be an example of or include components of a system 605 as described herein. The system 805 may include components for blockchain address aggregation including components for transmitting and receiving communications, such as a blockchain address aggregation manager 820, an input information 810, an output information 815, a network interface 825, at least one memory 830, at least one processor 835, and a storage 840. Each of these components may communicate, directly or indirectly, with one another (e.g., via one or more buses, communications links, communications interfaces, or any combination thereof).

The network interface 825 may enable the system 805 to exchange information (e.g., input information 810, output information 815, or both) with other systems or devices (not shown). For example, the network interface 825 may enable the system 805 to connect to a network (e.g., a network 135 as described herein). The network interface 825 may include one or more wireless network interfaces, one or more wired network interfaces, or any combination thereof.

Memory 830 may include RAM, ROM, or both. The memory 830 may store computer-readable, computer-executable software including instructions that, when executed, cause at least one processor 835 to perform various functions described herein, such as functions supporting a blockchain address aggregation service. In some cases, the memory 830 may contain, among other things, a basic input/output system (BIOS), which may control basic hardware or software operation such as the interaction with peripheral components or devices. In some cases, the memory 830 may be an example of aspects of one or more components of a custodial token platform 110 as described with reference to FIG. 1. The memory 830 may be an example of a single memory or multiple memories. For example, the system 805 may include one or more memories 830.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in at least one memory 830 to perform various functions (e.g., functions or tasks supporting a blockchain address aggregation service). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. The processor 835 may be an example of a single processor or multiple processors. For example, the system 805 may include one or more processors 835.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1.

For example, the blockchain address aggregation manager 820 may be configured as or otherwise support a means for receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network. The blockchain address aggregation manager 820 may be configured as or otherwise support a means for displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address. The blockchain address aggregation manager 820 may be configured as or otherwise support a means for receiving, via the user interface of the client application, one or more second user inputs to perform an operation on a blockchain network using a blockchain address of the plurality of blockchain addresses. The blockchain address aggregation manager 820 may be configured as or otherwise support a means for initiating, via the client application, the operation on the blockchain network after receiving the one or more second user inputs.

By including or configuring the blockchain address aggregation manager 820 in accordance with examples as described herein, the system 805 may support techniques for improved user experience and reduced processing complexity, resource overhead, or both related to aggregating multiple blockchain addresses at a single user interface.

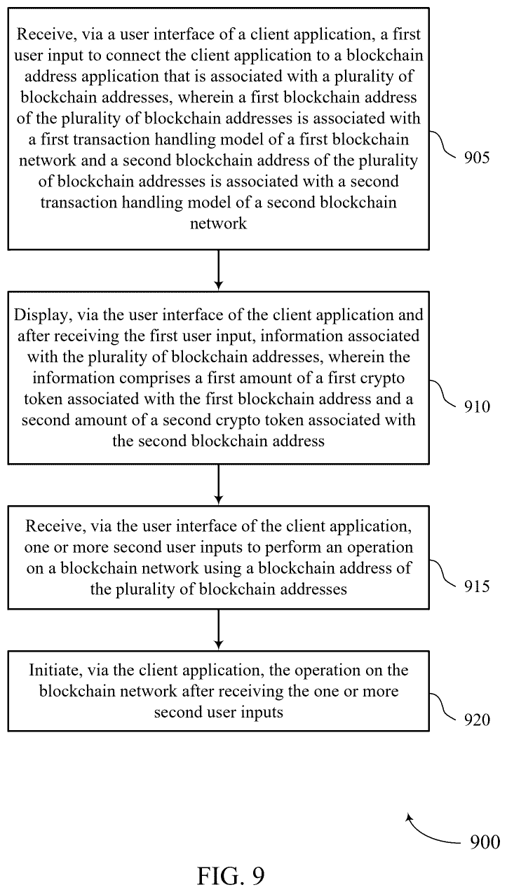

FIG. 9 shows a flowchart illustrating a method 900 that supports a blockchain address aggregation service in accordance with aspects of the present disclosure. The operations of the method 900 may be implemented by a client application or its components as described herein. For example, the operations of the method 900 may be performed by a client application as described with reference to FIGS. 1 through 8. In some examples, a client application may execute a set of instructions to control the functional elements of the client application to perform the described functions. Additionally, or alternatively, the client application may perform aspects of the described functions using special-purpose hardware.

At 905, the method may include receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network. The operations of 905 may be performed in accordance with examples as disclosed herein. In some examples, aspects of the operations of 905 may be performed by a user input component 725 as described with reference to FIG. 7.

At 910, the method may include displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address. The operations of 910 may be performed in accordance with examples as disclosed herein. In some examples, aspects of the operations of 910 may be performed by an information display component 730 as described with reference to FIG. 7.

At 915, the method may include receiving, via the user interface of the client application, one or more second user inputs to perform an operation on a blockchain network using a blockchain address of the plurality of blockchain addresses. The operations of 915 may be performed in accordance with examples as disclosed herein. In some examples, aspects of the operations of 915 may be performed by a user input component 725 as described with reference to FIG. 7.

At 920, the method may include initiating, via the client application, the operation on the blockchain network after receiving the one or more second user inputs. The operations of 920 may be performed in accordance with examples as disclosed herein. In some examples, aspects of the operations of 920 may be performed by a blockchain operation initiation component 735 as described with reference to FIG. 7.

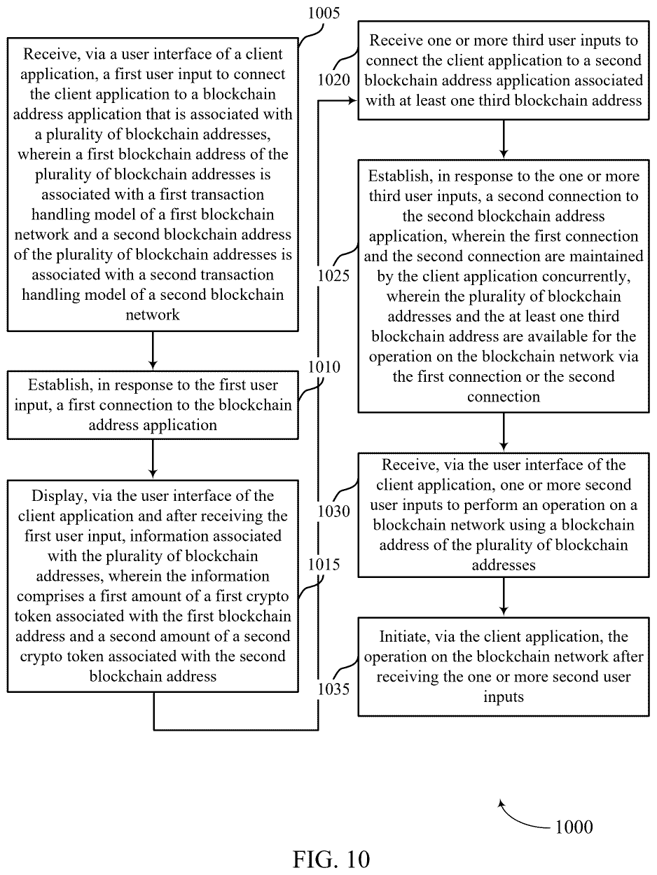

FIG. 10 shows a flowchart illustrating a method 1000 that supports a blockchain address aggregation service in accordance with aspects of the present disclosure. The operations of the method 1000 may be implemented by a client application or its components as described herein. For example, the operations of the method 1000 may be performed by a client application as described with reference to FIGS. 1 through 8. In some examples, a client application may execute a set of instructions to control the functional elements of the client application to perform the described functions. Additionally, or alternatively, the client application may perform aspects of the described functions using special-purpose hardware.

At 1005, the method may include receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network. The operations of 1005 may be performed in accordance with examples as disclosed herein. In some examples, aspects of the operations of 1005 may be performed by a user input component 725 as described with reference to FIG. 7.

At 1010, the method may include establishing, in response to the first user input, a first connection to the blockchain address application. The operations of 1010 may be performed in accordance with examples as disclosed herein. In some examples, aspects of the operations of 1010 may be performed by a connection establishment component 740 as described with reference to FIG. 7.

At 1015, the method may include displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address. The operations of 1015 may be performed in accordance with examples as disclosed herein. In some examples, aspects of the operations of 1015 may be performed by an information display component 730 as described with reference to FIG. 7.

At 1020, the method may include receiving one or more third user inputs to connect the client application to a second blockchain address application associated with at least one third blockchain address. The operations of 1020 may be performed in accordance with examples as disclosed herein. In some examples, aspects of the operations of 1020 may be performed by a user input component 725 as described with reference to FIG. 7.

At 1025, the method may include establishing, in response to the one or more third user inputs, a second connection to the second blockchain address application, wherein the first connection and the second connection are maintained by the client application concurrently, wherein the plurality of blockchain addresses and the at least one third blockchain address are available for the operation on the blockchain network via the first connection or the second connection. The operations of 1025 may be performed in accordance with examples as disclosed herein. In some examples, aspects of the operations of 1025 may be performed by a connection establishment component 740 as described with reference to FIG. 7.

At 1030, the method may include receiving, via the user interface of the client application, one or more second user inputs to perform an operation on a blockchain network using a blockchain address of the plurality of blockchain addresses. The operations of 1030 may be performed in accordance with examples as disclosed herein. In some examples, aspects of the operations of 1030 may be performed by a user input component 725 as described with reference to FIG. 7.

At 1035, the method may include initiating, via the client application, the operation on the blockchain network after receiving the one or more second user inputs. The operations of 1035 may be performed in accordance with examples as disclosed herein. In some examples, aspects of the operations of 1035 may be performed by a blockchain operation initiation component 735 as described with reference to FIG. 7.

A method by an apparatus is described. The method may include receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network, displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address, receiving, via the user interface of the client application, one or more second user inputs to perform an operation on a blockchain network using a blockchain address of the plurality of blockchain addresses, and initiating, via the client application, the operation on the blockchain network after receiving the one or more second user inputs.

An apparatus is described. The apparatus may include one or more memories storing processor executable code, and one or more processors coupled with the one or more memories. The one or more processors may individually or collectively be operable to execute the code to cause the apparatus to receive, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network, display, via the user interface of the client application and after receiving the first user input, information associated with the plurality of blockchain addresses, wherein the information comprises a first amount of a first crypto token associated with the first blockchain address and a second amount of a second crypto token associated with the second blockchain address, receive, via the user interface of the client application, one or more second user inputs to perform an operation on a blockchain network using a blockchain address of the plurality of blockchain addresses, and initiate, via the client application, the operation on the blockchain network after receiving the one or more second user inputs.

Another apparatus is described. The apparatus may include means for receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network, means for displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address, means for receiving, via the user interface of the client application, one or more second user inputs to perform an operation on a blockchain network using a blockchain address of the plurality of blockchain addresses, and means for initiating, via the client application, the operation on the blockchain network after receiving the one or more second user inputs.

A non-transitory computer-readable medium storing code is described. The code may include instructions executable by one or more processors to receive, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network, display, via the user interface of the client application and after receiving the first user input, information associated with the plurality of blockchain addresses, wherein the information comprises a first amount of a first crypto token associated with the first blockchain address and a second amount of a second crypto token associated with the second blockchain address, receive, via the user interface of the client application, one or more second user inputs to perform an operation on a blockchain network using a blockchain address of the plurality of blockchain addresses, and initiate, via the client application, the operation on the blockchain network after receiving the one or more second user inputs.

Some examples of the method, apparatus, and non-transitory computer-readable medium described herein may further include operations, features, means, or instructions for establishing, in response to the first user input, a first connection to the blockchain address application, receiving one or more third user inputs to connect the client application to a second blockchain address application associated with at least one third blockchain address, and establishing, in response to the one or more third user inputs, a second connection to the second blockchain address application, wherein the first connection and the second connection may be maintained by the client application concurrently, wherein the plurality of blockchain addresses and the at least one third blockchain address may be available for the operation on the blockchain network via the first connection or the second connection.

In some examples of the method, apparatus, and non-transitory computer-readable medium described herein, the operation on the blockchain network comprises an exchange of a third amount of a third crypto token associated with the blockchain address for a fourth amount of a fourth crypto token associated with a different blockchain address of the plurality of blockchain addresses and the blockchain address may be associated with the blockchain address application and the different blockchain address may be associated with the second blockchain address application.

In some examples of the method, apparatus, and non-transitory computer-readable medium described herein, the first blockchain address comprises a smart wallet that performs cryptographic operations using a passkey comprising a string of characters stored on a user device.

Some examples of the method, apparatus, and non-transitory computer-readable medium described herein may further include operations, features, means, or instructions for receiving, via the user interface of the client application and prior to the first user input, one or more third user inputs to create the smart wallet.

Some examples of the method, apparatus, and non-transitory computer-readable medium described herein may further include operations, features, means, or instructions for displaying, via the user interface of the client application, one or more third-party Dapps accessible via the client application and receiving, via the user interface of the client application, one or more third user inputs to access a third-party Dapp of the one or more third-party Dapps using the blockchain address of the plurality of blockchain addresses.

In some examples of the method, apparatus, and non-transitory computer-readable medium described herein, the information associated with the plurality of blockchain addresses further comprises one or more DeFi positions of respective blockchain addresses of the plurality of blockchain addresses.

Some examples of the method, apparatus, and non-transitory computer-readable medium described herein may further include operations, features, means, or instructions for transmitting a first request for the information associated with the first blockchain address to the first blockchain address, receiving, in response to the first request, a first response comprising the information associated with the first blockchain address, the information comprising the first amount of the first crypto token associated with the first blockchain address, transmitting a second request for information associated with the second blockchain address to the second blockchain address, and receiving, in response to the second request, a second response comprising the information associated with the second blockchain address, the information comprising the second amount of the second crypto token associated with the second blockchain address, wherein displaying the information may be based at least in part on the first response and the second response.

In some examples of the method, apparatus, and non-transitory computer-readable medium described herein, displaying the information may include operations, features, means, or instructions for displaying a summation of a first fiat amount and a second fiat amount, wherein: the first fiat amount corresponds to the first amount of the first crypto token according to a first exchange rate between a fiat and the first crypto token, and the second fiat amount corresponds to the second amount of the second crypto token according to a second exchange rate between the fiat and the second crypto token.

Some examples of the method, apparatus, and non-transitory computer-readable medium described herein may further include operations, features, means, or instructions for receiving, via the user interface of the client application, one or more third user inputs to display information associated with the first crypto token and displaying, via the user interface of the client application and in response to the one or more third user inputs, the information associated with the first crypto token, the information comprising the first amount of the first crypto token associated with the first blockchain address.

In some examples of the method, apparatus, and non-transitory computer-readable medium described herein, one or more visual representations of the plurality of blockchain addresses may be displayed for selection for performance of the operation on the blockchain network.

In some examples of the method, apparatus, and non-transitory computer-readable medium described herein, the operation on the blockchain network comprises an exchange of a third amount of a third crypto token associated with the blockchain address for a fourth amount of a fourth crypto token associated with a different blockchain address of the plurality of blockchain addresses and the method, apparatuses, and non-transitory computer-readable medium may include further operations, features, means, or instructions for updating, after initiating the operation on the blockchain network, the user interface of the client application to display updated information, the updated information comprising the third amount of the third crypto token associated with the different blockchain address and the fourth amount of the fourth crypto token associated with the blockchain address.

Some examples of the method, apparatus, and non-transitory computer-readable medium described herein may further include operations, features, means, or instructions for establishing, in response to the first user input, a connection to a blockchain address application associated with the plurality of blockchain addresses, wherein the plurality of blockchain addresses may be available for the operation on the blockchain network via the connection.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network;
displaying, via the user interface of the client application and after receiving the first user input, information associated with the plurality of blockchain addresses, wherein the information comprises a first amount of a first crypto token associated with the first blockchain address and a second amount of a second crypto token associated with the second blockchain address;
receiving, via the user interface of the client application, one or more second user inputs to perform an operation on a blockchain network using a blockchain address of the plurality of blockchain addresses; and
initiating, via the client application, the operation on the blockchain network after receiving the one or more second user inputs.

2. The method of claim 1, further comprising:
establishing, in response to the first user input, a first connection to the blockchain address application;
receiving one or more third user inputs to connect the client application to a second blockchain address application associated with at least one third blockchain address; and
establishing, in response to the one or more third user inputs, a second connection to the second blockchain address application, wherein the first connection and the second connection are maintained by the client application concurrently, wherein the plurality of blockchain addresses and the at least one third blockchain address are available for the operation on the blockchain network via the first connection or the second connection.

3. The method of claim 2, wherein the operation on the blockchain network comprises an exchange of a third amount of a third crypto token associated with the blockchain address for a fourth amount of a fourth crypto token associated with a different blockchain address of the plurality of blockchain addresses, and the blockchain address is associated with the blockchain address application and the different blockchain address is associated with the second blockchain address application.

4. The method of claim 1, wherein the first blockchain address comprises a smart wallet that performs cryptographic operations using a passkey comprising a string of characters stored on a user device.

5. The method of claim 4, further comprising:
receiving, via the user interface of the client application and prior to the first user input, one or more third user inputs to create the smart wallet.

6. The method of claim 1, further comprising:
displaying, via the user interface of the client application, one or more third-party decentralized applications (Dapps) accessible via the client application; and
receiving, via the user interface of the client application, one or more third user inputs to access a third-party Dapp of the one or more third-party Dapps using the blockchain address of the plurality of blockchain addresses.

7. The method of claim 1, wherein the information associated with the plurality of blockchain addresses further comprises one or more decentralized finance (DeFi) positions of respective blockchain addresses of the plurality of blockchain addresses.

8. The method of claim 1, further comprising:
transmitting a first request for the information associated with the first blockchain address to the first blockchain address;
receiving, in response to the first request, a first response comprising the information associated with the first blockchain address, the information comprising the first amount of the first crypto token associated with the first blockchain address;
transmitting a second request for information associated with the second blockchain address to the second blockchain address; and
receiving, in response to the second request, a second response comprising the information associated with the second blockchain address, the information comprising the second amount of the second crypto token associated with the second blockchain address, wherein displaying the information is based at least in part on the first response and the second response.

9. The method of claim 1, wherein displaying the information further comprises:
displaying a summation of a first fiat amount and a second fiat amount, wherein: the first fiat amount corresponds to the first amount of the first crypto token according to a first exchange rate between a fiat and the first crypto token, and the second fiat amount corresponds to the second amount of the second crypto token according to a second exchange rate between the fiat and the second crypto token.

10. The method of claim 1, further comprising:
receiving, via the user interface of the client application, one or more third user inputs to display information associated with the first crypto token; and
displaying, via the user interface of the client application and in response to the one or more third user inputs, the information associated with the first crypto token, the information comprising the first amount of the first crypto token associated with the first blockchain address.

11. The method of claim 1, wherein one or more visual representations of the plurality of blockchain addresses are displayed for selection for performance of the operation on the blockchain network.

12. The method of claim 1, wherein the operation on the blockchain network comprises an exchange of a third amount of a third crypto token associated with the blockchain address for a fourth amount of a fourth crypto token associated with a different blockchain address of the plurality of blockchain addresses, the method further comprising:
updating, after initiating the operation on the blockchain network, the user interface of the client application to display updated information, the updated information comprising the third amount of the third crypto token associated with the different blockchain address and the fourth amount of the fourth crypto token associated with the blockchain address.

13. The method of claim 1, further comprising:
establishing, in response to the first user input, a connection to a blockchain address application associated with the plurality of blockchain addresses, wherein the plurality of blockchain addresses are available for the operation on the blockchain network via the connection.

14. An apparatus, comprising:
one or more memories storing processor-executable code; and
one or more processors coupled with the one or more memories and individually or collectively operable to execute the code to cause the apparatus to:
receive, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network;
display, via the user interface of the client application and after receiving the first user input, information associated with the plurality of blockchain addresses, wherein the information comprises a first amount of a first crypto token associated with the first blockchain address and a second amount of a second crypto token associated with the second blockchain address;
receive, via the user interface of the client application, one or more second user inputs to perform an operation on a blockchain network using a blockchain address of the plurality of blockchain addresses, wherein the operation comprises a transfer of the first crypto token from the first blockchain address to a third blockchain address associated with a second blockchain address application connected to the client application;
initiate, via the client application, the operation on the blockchain network after receiving the one or more second user inputs; and
display, via the user interface, a result of the transfer of the first crypto token to the third blockchain address.

15. The apparatus of claim 14, wherein the one or more processors are individually or collectively further operable to execute the code to cause the apparatus to:
establish, in response to the first user input, a first connection to the blockchain address application;
receive one or more third user inputs to connect the client application to a second blockchain address application associated with at least one third blockchain address; and
establish, in response to the one or more third user inputs, a second connection to the second blockchain address application, wherein the first connection and the second connection are maintained by the client application concurrently, wherein the plurality of blockchain addresses and the at least one third blockchain address are available for the operation on the blockchain network via the first connection or the second connection.

16. The apparatus of claim 15, wherein:
the operation on the blockchain network comprises an exchange of a third amount of a third crypto token associated with the blockchain address for a fourth amount of a fourth crypto token associated with a different blockchain address of the plurality of blockchain addresses, and
the blockchain address is associated with the blockchain address application and the different blockchain address is associated with the second blockchain address application.

17. The apparatus of claim 14, wherein the first blockchain address comprises a smart wallet that performs cryptographic operations using a passkey comprising a string of characters stored on a user device.

18. A non-transitory computer-readable medium storing code, the code comprising instructions executable by one or more processors to:
receive, via a user interface of a client application, a first user input to connect the client application to a blockchain address application that is associated with a plurality of blockchain addresses, wherein a first blockchain address of the plurality of blockchain addresses is associated with a first transaction handling model of a first blockchain network and a second blockchain address of the plurality of blockchain addresses is associated with a second transaction handling model of a second blockchain network;
display, via the user interface of the client application and after receiving the first user input, information associated with the plurality of blockchain addresses, wherein the information comprises a first amount of a first crypto token associated with the first blockchain address and a second amount of a second crypto token associated with the second blockchain address, wherein the information comprises a first amount of a first crypto token associated with the first blockchain address and a second amount of a second crypto token associated with a third blockchain address associated with a second blockchain address application connected to the client application;
receive, via the user interface of the client application, one or more second user inputs to perform an operation on a blockchain network using a blockchain address of the plurality of blockchain addresses; and
initiate, via the client application, the operation on the blockchain network after receiving the one or more second user inputs.

19. The non-transitory computer-readable medium of claim 18, wherein the instructions are further executable by the one or more processors to:
establish, in response to the first user input, a first connection to the blockchain address application;
receive one or more third user inputs to connect the client application to a second blockchain address application associated with at least one third blockchain address; and
establish, in response to the one or more third user inputs, a second connection to the second blockchain address application, wherein the first connection and the second connection are maintained by the client application concurrently, wherein the plurality of blockchain addresses and the at least one third blockchain address are available for the operation on the blockchain network via the first connection or the second connection.

20. The non-transitory computer-readable medium of claim 19, wherein:
the operation on the blockchain network comprises an exchange of a third amount of a third crypto token associated with the blockchain address for a fourth amount of a fourth crypto token associated with a different blockchain address of the plurality of blockchain addresses, and
the blockchain address is associated with the blockchain address application and the different blockchain address is associated with the second blockchain address application.
